(19) United States
(12) Patent Application Publication
(10) Pub. No.: US 2014/0024351 A1
(43) Pub. Date: Jan. 23, 2014

(54) MESSAGE CONSOLIDATION SYSTEM

(71) Applicant: TIP Solutions, Inc., Chicago, IL (US)

(72) Inventors: John T. Braun, Vernon Hills, IL (US); Michael Unetich, Chicago, IL (US); Daniel P. Quigley, Woodinville, IL (US)

(21) Appl. No.: 13/943,132

(22) Filed: Jul. 16, 2013

Related U.S. Application Data
(60) Provisional application No. 61/673,859, filed on Jul. 20, 2012.

(51) Int. Cl. H04W 4/16

(52) U.S. Cl. CPC H04W 4/16
USPC 455/415

(57) ABSTRACT

A message consolidation system includes a plurality of mobile communication devices connected to a network, a plurality of telecommunication switching units connected to a plurality of communication units and to the network and a consolidation unit on the network. The consolidation unit is configured to logically relate at least two communication devices, and to extract call information from each of the mobile communication devices and switching devices and to store the extracted data in a memory of the consolidation unit for display on a display unit coupled to a client device.

### BACKGROUND

The present invention is directed to a device and method for consolidating call logs from multiple sources and displaying the call logs to a user.

Conventional phone systems allow a user to view a listing of incoming calls. Many of these systems also display a listing of all phone numbers calling a device, with the list indicating whether a call was connected. If a call is not connected, the call is said to be a “missed call.” Conventional phone systems independently store a listing of missed calls for each phone connected to the phone system. However, many users use more than one communication device, such as a cellular phone, office phone, and home phone. Because each communication device has a separate call log, a user must search through multiple call logs to determine if a call has been missed.

Accordingly, a need exists for a system that consolidates all of the call logs from various devices and allows a user to view the call log from any device.

### SUMMARY

Various embodiments of the present invention include a message consolidation system including a plurality of mobile communication devices connected to a network, a plurality of telecommunication switching units connected to a plurality of communication units and to the network, and a consolidation unit on the network. The consolidation unit is configured to logically relate at least two communication devices and to extract call information from each of the mobile communication devices and switching devices and to store the extracted data in a memory of the consolidation unit for display on a display unit coupled to a client device.

In an embodiment, the message consolidation unit extracts additional information pertaining to the phone numbers in the extracted call information. The additional information can include information indicating if a call was successfully connected or missed.

The consolidation unit can be configured to post a message on an external web site based on a status of a call in the extracted call information. The consolidation unit can also be configured to determine if a return call was initiated based on the call information.

In an embodiment, the consolidation unit displays a listing of missed and received calls for each of the related communication devices.

In an embodiment, the message consolidation system includes a consolidation unit configured to logically relate at least one mobile communication device connected to a network and at least one telecommunication switching unit connected to a plurality of communication units and to the network. The consolidation unit is configured to extract call information from the at least one mobile communication device and the at least one switching device and to store the extracted data in a memory of the consolidation unit for display on a display unit coupled to a client device.

In an embodiment, the consolidation unit extracts additional information pertaining to the phone numbers in the extracted call information. In such a consolidation system, the additional information can include information indicating if a call was successfully connected or missed.

The consolidation unit can be configured to post a message on an external web site based on a status of a call in the extracted call information and to determine if a return call was initiated based on the call information. In any of the embodiments, the consolidation unit can display a listing of missed and received calls for each of the related communication devices. In an embodiment, the consolidation unit can be configured to logically relate at least two mobile communication devices.

Another embodiment includes a method of consolidating call information from a plurality of logically related communication devices connected to a network. The method includes the steps of connecting to each of the communication devices or to a telecommunication switch unit communicatively coupled to at least one of the communication devices, extracting call information from each of the communication devices or the corresponding telecommunication switch units, storing the extracted call information in a memory of a consolidation unit, and displaying the call information for at least two logically related communication devices on a display via the consolidation unit.

The method can include extracting additional information pertaining to the phone numbers in the extracted call information. Such additional information can include information indicating if a call was successfully connected or missed.

Any of the methods can include posting a message on an external web site based on a status of a call in the extracted call information, and can include the step of determining if a return call was initiated based on the call information. In addition, any of the methods can also include, including the step of displaying a listing of missed and received calls for each of the related communication devices, and can include the steps of extracting a list of outgoing calls from each of the communication devices or the corresponding telecommunication switch units, and matching the phone numbers and call times of each missed call with an outgoing phone call to determine if a return call has been placed.

These and other features and advantages of the present invention will be apparent from the following detailed description, in conjunction with the appended claims.

### DESCRIPTION OF THE DRAWINGS

Details of the present invention, including non-limiting benefits and advantages, will become more readily apparent to those of ordinary skill in the relevant art after reviewing the following detailed description and accompanying drawings, wherein:

FIG. 1 depicts a block diagram of a message consolidation system suitable for use with the methods and systems consistent with the present invention;

FIG. 2A shows a more detailed depiction of the message consolidation unit of FIG. 1;

FIG. 2B shows a more detailed depiction of a client device included in the system of FIG. 1;

FIG. 3 illustrates a mobile communication device included in the system of FIG. 1;

FIG. 4 illustrates a schematic representation of the interaction between an application processing unit and a radio communication unit included in the system of FIG. 1;

FIG. 5 depicts a schematic representation of the process of consolidating call logs from multiple devices utilizing the system of FIG. 1;

FIG. 6 depicts a schematic representation of the operation of the radio interface unit of FIG. 2B;

FIG. 7 depicts the operation of gathering call log information from multiple devices on the network in FIG. 1;

FIG. 8 depicts a schematic representation of a configuration user interface; and

FIG. 9 depicts a schematic representation of the operation of a consolidation unit included in the system of FIG. 1.

### DETAILED DESCRIPTION

While the present invention is susceptible of embodiment in various forms, there is shown in the drawings and will hereinafter be described one or more embodiments with the understanding that the present disclosure is to be considered illustrative only of the invention and is not intended to limit the invention to any specific embodiment disclosed herein.

The present disclosure is directed to one or more communication devices capable of transmitting an audio signal over a wireless network, such as a cellular network. The transmission of the audio signal may be part of a larger communication management system which is used to notify callers that the user of the mobile communication device is unavailable. The audio signal may be sent as a single transmission, or may be appended to another audio signal that was received in real time.

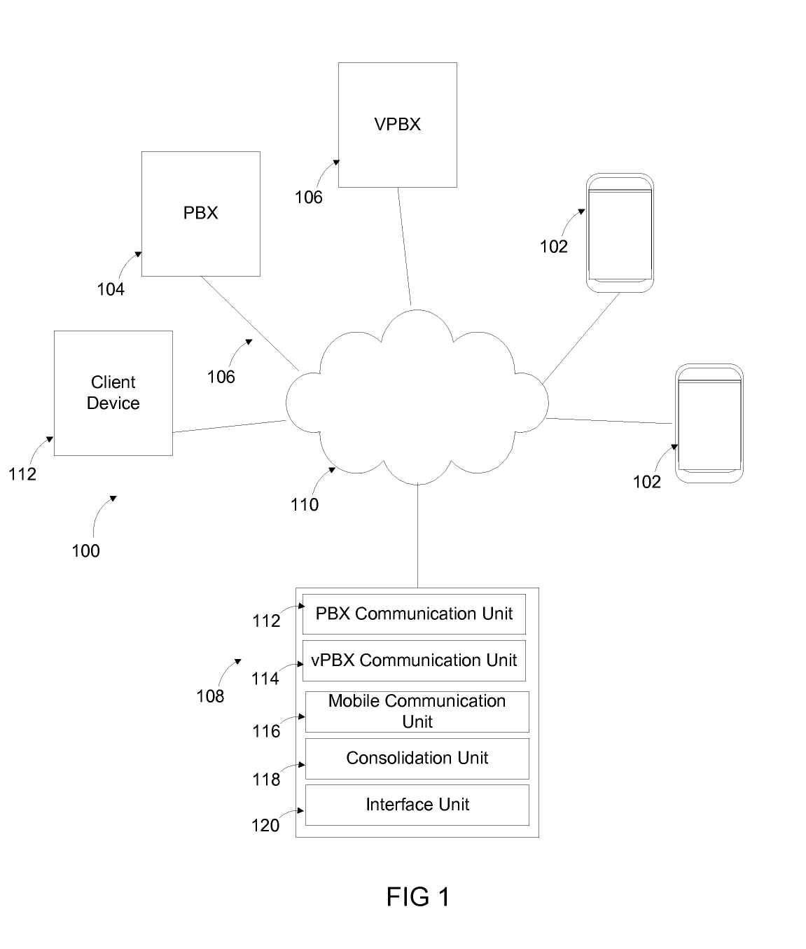

FIG. 1 depicts a block diagram of a message consolidation system 100 suitable for use with the methods and systems consistent with the present invention. The message consolidation system 100 comprises a plurality of communication devices 102, a private branch exchange (PBX) 104, a virtual PBX (vPBX) 106, and a message consolidation unit 108, all of which are connected via a network 110. The PBX 104 may be any conventional PBX 104 that is used to connect a plurality of phones together. The PBX 104 may be directly connected to the network 110, or may be connected to the network using a gateway (not shown). The vPBX 106 can be any known vPB 106. The vPBX 106 is used to connect internet protocol (IP) phones together, and the vPBX 106 may be directly connected to the network 110.

The network 110 is of a type that is suitable for connecting the PBX 104, vPBX 106, and mobile communication devices 102 together for communication, such as a circuit-switched network or a packet-switched network. Also, the network 110 may include a number of different networks, such as a local area network, a wide area network such as the Internet, telephone networks including telephone networks with dedicated communication links, connection-less network, and wireless networks. In the illustrative example shown in FIG. 1, the network 110 is the Internet. Each of the devices shown in FIG. 1 is connected to the network 110 via a suitable communication link, such as a dedicated communication line or a wireless communication link.

The number of devices and the network 110 configuration shown in FIG. 1 are merely an illustrative example. One having skill in the art will appreciate that the system may include a different number of devices and networks. The system 100 may also include a plurality of client devices 112, which allow a user to view and configure portions of the system as described herein.

The message consolidation unit 108 includes a PBX communication unit 112, a vPBX communication unit 114, a mobile communication unit 116, a consolidation unit 118, and an interface unit 120. The PBX communication unit 112 and vPBX communication unit 114 are configured to communication with, and extract data from, the PBX 104 and vPBX 106 via the network 110. The mobile communication unit 116 is configured to communicate, and extract data from, each of the plurality of mobile communication devices 102. The consolidation unit 118 is configured to gather information from the communication units 112, 114, 116 and consolidate the information into a single source. The interface unit 120 is configured to rectify the information from the consolidation unit and display the information via the network 110.

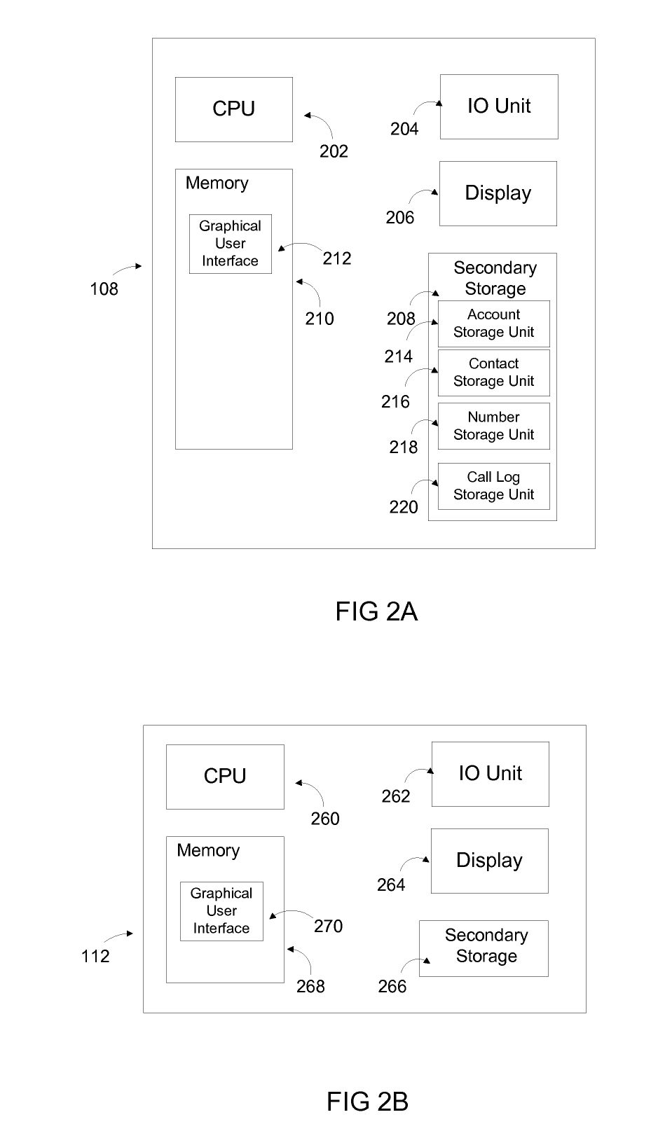

FIG. 2A shows a more detailed depiction of the message consolidation unit 108. The message consolidation unit 108 comprises a central processing unit (CPU) 202, an input output (I/O) unit 204, a display device 206, a secondary storage device 208, and a memory 210. The message consolidation unit 108 may further comprise standard input devices such as a keyboard, a mouse, a digitizer, or a speech processing means (each not illustrated).

The message consolidation unit 108's memory 210 includes a Graphical User Interface (“GUI”) 212, which is used to gather information from a user via the display device 206 and I/O unit 204, as described herein. The GUI 212 includes any user interface capable of being displayed on a display device 206 including, but not limited to, a web page, a display panel in an executable program, or any other interface capable of being displayed on a computer screen. The secondary storage device 208 includes an account storage unit 214, a contact storage unit 216, a number storage unit 218, and a call log storage unit 220. Further, the GUI 212 may also be stored in the secondary storage unit 208. In one embodiment consistent with the present invention, the GUI 212 is displayed using commercially available hypertext markup language (“HTML”) viewing software such as, but not limited to, Microsoft Internet Explorer®, Google Chrome® or any other commercially available HTML viewing software presently known or to be developed.

FIG. 2B shows a more detailed depiction of the client device 112. The client device comprises a central processing unit (CPU) 260, an input output (I/O) unit 262, a display device 264, a secondary storage device 266, and a memory 268. The client device 112 may further comprise standard input devices such as a keyboard, a mouse, a digitizer, or a speech processing means (each not illustrated).

The client device 112′s memory 268 includes a Graphical User Interface (“GUI”) 270, which is used to gather information from a user via the display device 264 and I/O unit 262, as described herein. The GUI 270 includes any user interface capable of being displayed on a display device 264 including, but not limited to, a web page, a display panel in an executable program, or any other interface capable of being displayed on a computer screen. The GUI 270 may also be stored in the secondary storage unit 266. In one embodiment consistent with the present invention, the GUI 270 is displayed using commercially available hypertext markup language (“HTML”) viewing software such as, but not limited to, Microsoft Internet Explorer®, Google Chrome® or any other commercially available HTML viewing software presedntly known or to be developed.

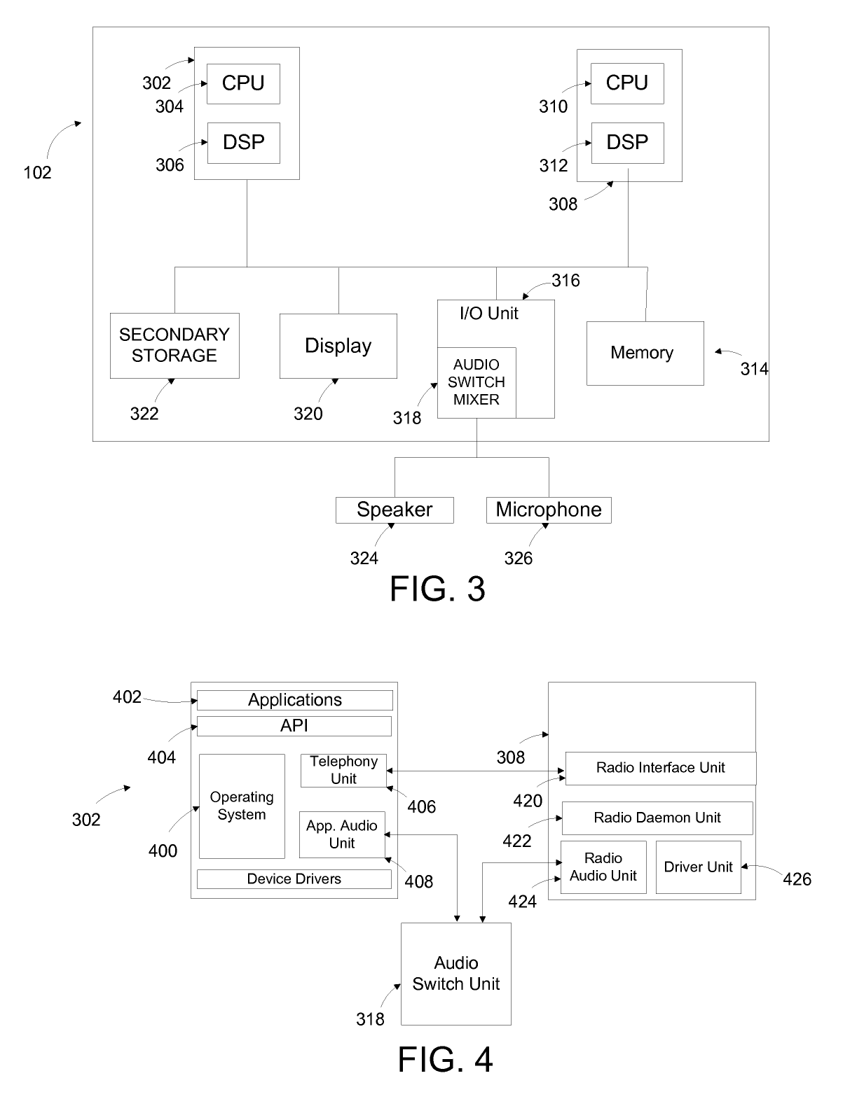

FIG. 3 illustrates a mobile communication device 102. The mobile communication device 102 includes an application processing unit 302 that includes a central processing unit (CPU) 304 and a digital signal processor (DSP) 306, a radio communication unit 308 that includes a CPU 310 and DSP 312, a memory 314, an input output (10) unit 316 that includes an audio switch unit 318, a display 320, and a secondary storage unit 322. The radio communication unit 308 is configured to communicate across a wireless network. The radio communication unit 308 may be configured to communicate over a wireless cellular network using any cellular protocol including, but not limited to, code division multiple access (CDMA), global system for mobile communications (GSM), and universal mobile telecommunications system (UMTS), or any other cellular communication protocol presently known or to be developed. The wireless network may also be directly, or indirectly, connected to the network 110.

The IO unit 316 is coupled to a speaker 324 and a microphone 326 via the audio switch unit 318. The audio switch unit 318 is configured to receive an audio signal from the microphone 326, and to adjust various characteristics of the received audio signal. The audio switch unit 318 may adjust the volume of the audio, side tone generation, comfort noise generation, echo cancelation, automatic gain, noise suppression, tone generation, or any other characteristic of the audio signal. The audio switch unit 318 also routes audio signals received by the microphone 326 to the application processing unit 302, or the radio communication unit 308, and also routes audio from the application processing unit 302 and radio communication unit 308 to the speaker 324.

FIG. 4 illustrates a schematic representation of the interaction between the application processing unit 302 and radio communication unit 308. The application processing unit 302 includes an operating system 400 running in the CPU 304 of the application processing unit 302. The operating system 400 may be any commercially available operating system including Linux, Windows Mobile, Google Android, or any other operating system presently know or to be developed that is capable of running on a mobile communication device 102. The operating system 400 controls the operation of the CPU 304 and DSP 306 in the application processing unit 302. An application 402 operating in the operating system 400 interacts with different components of the mobile communication device 102, such as the display 320, speaker 324, and microphone 326, via an application programming interface (API) 404.

The radio communication unit 308 includes a radio interface unit 420, a radio daemon unit 422, a radio audio unit 424, and a driver unit 426 operating via the CPU 310 and DSP 312. The radio audio unit 424 is communicatively coupled to the audio switch unit 318, such that the audio switch unit 318 transmits audio captured by the microphone 326 for transmission over the wireless network by radio hardware coupled to the driver unit 426. The radio audio unit 424 also transmits audio information received from the radio hardware via the driver unit 426 to the speaker 326 via the audio switch unit 318.

The radio interface unit 420 performs high level operations to initiate a connection between the mobile communication device 102 and another device connected to the wireless network via the driver unit 426. The radio interface unit 420 is also communicatively coupled to a telephony unit 406 in the application processing unit 302. As an illustrative example, the radio interface unit 420 may receive a command from the telephony unit 406 to initiate a phone call between two mobile communication devices 102. The radio interface unit 420 communicates with the radio audio unit 424 and driver unit 426, via the radio daemon unit 422, to connect to the wireless network and initiate a call between the two communication devices 102. The radio interface unit 420 also communicates with the telephony unit 406 to notify the telephony unit 406 that a phone call has been initiated either by the mobile communication device 102 or by an external device that is calling the mobile device 102. The telephony unit 406 communicates with the application 402 running in the application processing unit 302 to provide a status of the radio transmission unit 408, and to initiate actions in the radio transmission unit 308. The radio interface unit 420 also transmits data, received from the wireless network, to the telephony unit 406.

The radio audio unit 424 in the radio communication unit 308 is communicatively coupled to the audio switch unit 318, such that the radio audio unit 424 instructs the audio switch unit 318 to send audio signals from the microphone 326 to the radio audio unit 424, and to transmit audio signals from radio audio unit 424 to the speaker 324 via the audio switch unit 318. The hardware driver unit 426 is communicatively coupled to the radio hardware in the mobile communication device 102 such that the hardware driver unit 426 initiates a connection with a wireless network, via the radio hardware, and controls the transmission and receipt of audio signals onto and from the wireless network. The hardware driver unit 426 is communicatively coupled to the radio audio unit 424 via the radio interface unit 420 and the radio daemon unit 422, such that the radio audio unit 424 provides audio signals from the microphone 326 to the hardware driver unit 426 for transmission over the wireless network. The hardware driver unit 426 also transmits audio signals received from the wireless network to the radio audio unit 424 for transmission to the speaker 324.

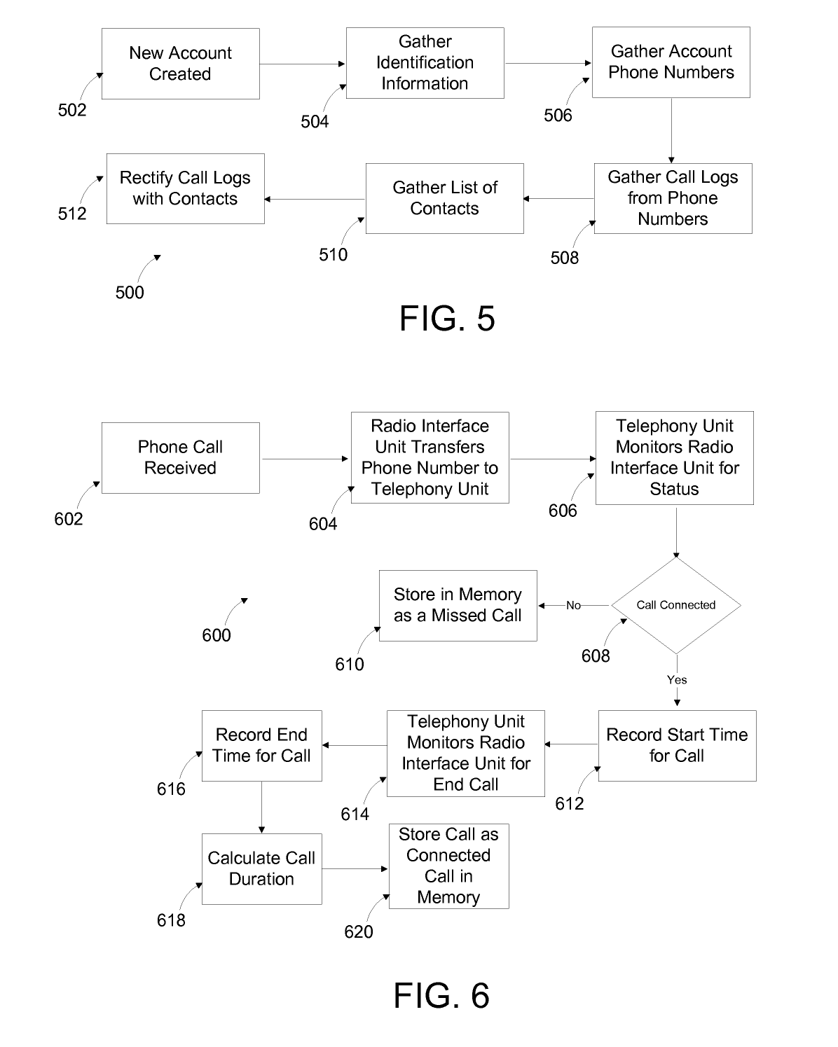

FIG. 5 depicts the process of consolidating call logs from multiple devices. In step 502, the interface unit 120 gathers account information via the GUI 212. In step 504, the interface unit 120 gathers information from the user via GUI 212. The information may include the first and last name of the user, a screen name, and an e-mail address for the user. In step 506, the interface unit 120 gathers at least one phone number via the GUI 212, and stores the numbers in the number storage unit 218. The phone numbers gathered may be categorized in the number storage unit 218 as wired or wireless telephone numbers. As an illustrative example, the GUI 212 may gather a cellular phone number, a phone number for a wired phone, and a phone number for a voice over internet (VOIP) phone. The interface unit 120 may also gather the network 110 addresses the PBX 104, or vPBX 106, of any phone numbers connected to the network 110 via a PBX 104, or vPBX 106.

In step 508, the consolidation unit 118 connects to each of the mobile communication devices 102, PBX 104s, or vPBX 106s for each of the phone numbers associated with the gathered phone numbers, and retrieves the information stored in the call log for each device. The retrieved information is stored in the call log storage unit 220, and is associated with the phone number in the number storage unit 218 that is associated with the communication device initiating the call. In step 510, the consolidation unit 118 retrieves the contact lists from the devices associated with the phone numbers for each account, and stores the extracted contact information in the contact storage unit 216. In step 512, the interface unit 120 rectifies each of the phone numbers in the call log storage unit 220 with contacts stored in the contact storage unit 216. If a phone number in the call log storage unit 220 matches a phone number associated with a contact in the contact storage unit 216, the interface unit 120 will associate the contact information in the contact storage unit 216 with any entries of the phone number in the call log storage unit 220.

FIG. 6 depicts a schematic representation of the operation of the radio interface unit 420. The radio interface unit 420 is configured to interact with the wireless network and to communicatively couple an external communication device with the mobile communication device 102. The radio interface unit 420 receives identification information as part of the request from the external communication device to connect an external communication device to the mobile communication device 102. In step 602, the radio interface unit 420 receives a request from an external communication device to initiate a call. When the call is received, the radio interface unit 420 transmits the identification information from the external device to the telephony unit 406 in step 604. The telephony unit 406 transfers the identification information to the application 102 where the identification information is stored in memory 314 with the date and time the call was received. In step 606, the telephony unit 406 monitors the status of the connection to the external device via the radio interface unit 420. In step 608, the telephony unit 406 determines if the external communication device is connected to the communication device 102.

In step 610, if the call is not connected, the application 102 stores the identification information in the memory 314 as a missed call. In step 612, if the call is connected, the application 102 stores the start time of the call in the memory 314. In step 614, the telephony unit monitors the radio interface unit 120 for notification that the call has terminated. In step 616, the application 102 records the time when the call terminates. In step 618, the application 102 calculates the call duration, and stores the call duration in the memory 314 of the device 102. In step 620, the application 102 stores the identification information as a connected call.

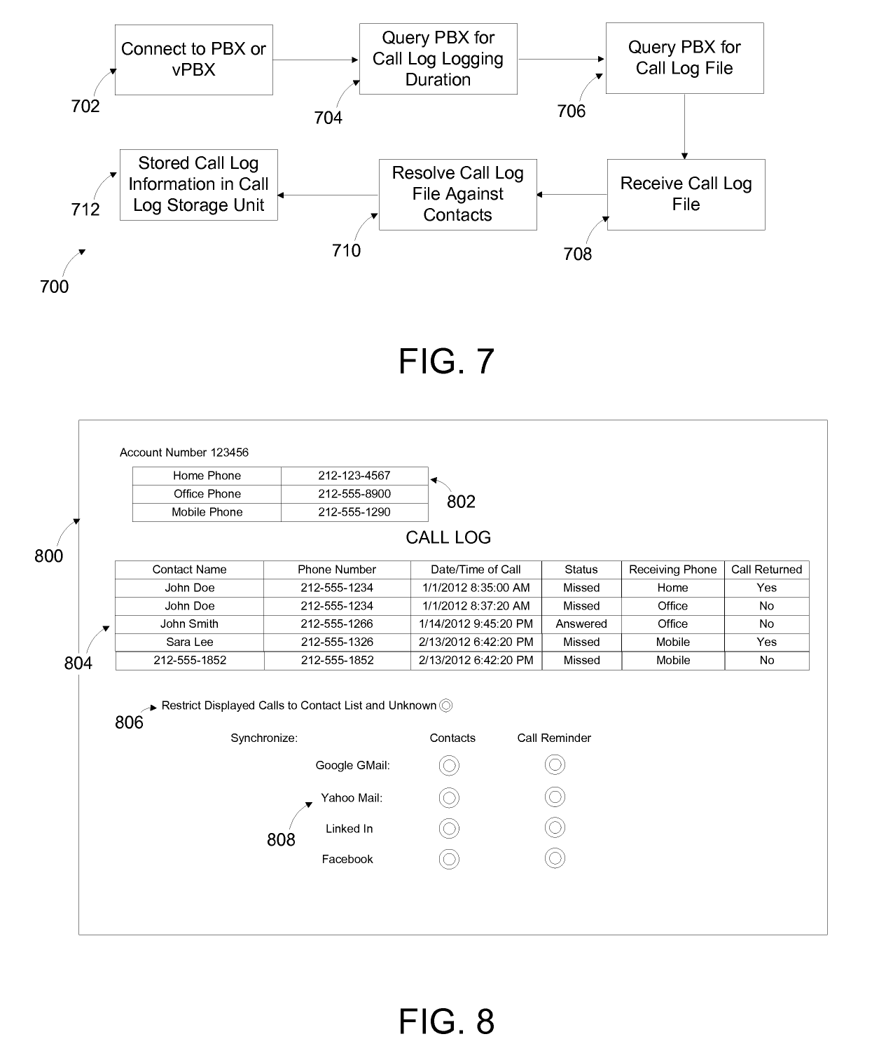

FIG. 7 depicts the operation of the mobile communication unit 116, PBX communication unit 112, or vPBX communication unit 114, to gather call log information from a PBX 104, or vPBX 106, connected to the network 110. In step 702, the application connects to a PBX 104, or vPBX 106, or mobile communication unit 102 connected to the network 110 via the PBX communication unit 112, vPBX communication unit 114, or mobile communication unit 116 operating on the message consolidation unit 108. The connection may be established directly with the PBX 104 or via a gateway connected to the PBX 104 and the network 110. The PBX 104 and vPBX 106 using any known communication protocol including, but not limited to, Microsoft Telephony Application Programming Interface (TAPI), Java TAPI (JTAPI), or any other known or to be developed communication protocol. The PBX communication unit 112, or vPBX communication unit 114, may also interface with the PBX 104, or vPBX 106, using customized communication interfaces.

In step 704, after the connection is established, the consolidation unit 118 requests the storage duration of the call log for each phone number associated with the account. The storage duration is used to determine the frequency with which the PBX communication unit 112, or vPBX communication unit 114, queries the devices to update the call log information. If a duration is not returned, a predetermined duration is applied for the non-responding device. In step 706, the PBX communication unit 112, or vPBX communication unit 106, transmits a request to the PBX 104, or vPBX 106, for the call log associated with a specific phone number connected to the PBX 104, or vPBX 106. In step 708, the PBX communication unit 112, vPBX communication unit 106, or mobile communication unit 116 receives the call log from the PBX 104, or vPBX 106, and temporarily stores the call log in the memory 210 of the message consolidation unit 108. In step 710, the consolidation unit 118 compares the phone numbers in the call log to the phone numbers stored in the contact storage unit 216, and resolves any known phone numbers with the information in the contact storage unit 216. In step 712, the resolved call log is stored in the call log storage unit 220.

The call log information retrieved may include the phone number of the incoming call, an indication of whether the call was connected, the start time of the call, the end time of the call, and any other additional information pertaining to each call. The PBX communication unit 104, vPBX communication unit 106, and mobile communication unit 116 may also receive call information directly from a PBX, vPBX, or mobile communication device via E-mail or a short messaging service (SMS) message. Consistent with this embodiment, the PBX communication unit 104, vPBX communication unit 106, and mobile communication unit 116 opens each e-mail, or SMS message and extracts call information from the message, which is then stored in the call log storage unit 220 using any of the methods previously described herein.

FIG. 8 depicts a schematic representation of an exemplary configuration interface displayed on the GUI 270 of the client device 112. The interface 800 includes an account information portion 802 that displays the account number of the user and the phone numbers associated with account. A listing of all received calls is displayed in the call log portion 804. The call log portion 804 displays the contact name from the contact storage unit 216, if available, or the phone number of the device making the call. The call log portion 804 also displays the time and date the call was received or missed, the status of the call, and the phone where the call was received. The call log 804 may also include an indication of whether the call was returned. The interface 800 also includes a configuration portion 806 that allows users to restrict the information displayed in the call list.

The configuration portion 806 also includes a synchronization section 808 that allows users to synchronize contacts, and to post call reminders, to different e-mail and social messaging web sites. To synchronize contact information, the user selects the appropriate web sites to synchronize, and the interface prompts the user to enter the user name and password for the site. The consolidation unit 118 then contacts each site and requests an export of the contact information for the users account. The consolidation unit 108 then analyzes the contact information to determine whether the contact information currently resides in the contact storage unit 216, and only adds contacts having phone numbers different than the phone number currently stored in the contact storage unit 216.

The interface unit 120 periodically connects to each of the web sites using the user name and password supplied by the user for each site, and creates reminders to contact any of the numbers associated with the logged calls. The configuration portion 806 may include a section where the user can restrict the interface unit 116 from creating reminders to return calls to only members of the contact list associated with the account. The interface unit 120 may also automatically change the status of a user on a social media site based on predefined criteria, such as indicating a person is not available based on a predetermined number of missed calls over a predetermined time period. As an illustrative example if four phone calls are missed in a fifteen minute period, the interface unit 120 may connect to Facebook to post a message on the user's page indicating the person may not be available.

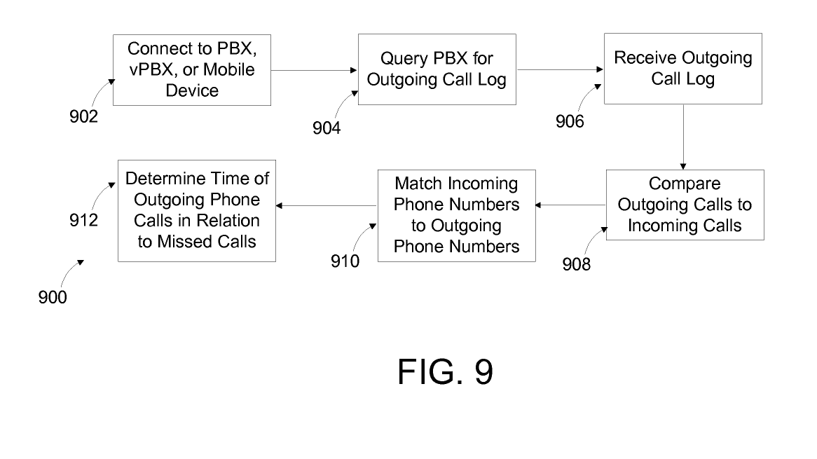

FIG. 9 depicts a schematic representation of the consolidation unit 118 determining if a return phone call is placed in response to a missed call. In step 902, the consolidation unit 118 connects to each PBX 104, vPBX 106, and mobile communication device 102. In step 904, after a connection is established, the consolidation unit 118 requests outgoing call information from each device. The outgoing call information may include the outgoing phone number and the date and time of each outgoing call. In step 906, the consolidation unit 118 receives the outgoing call information from each device and stores each event in the call log storage unit 220 as an outgoing call. In step 908, the consolidation unit 118 compares the outgoing calls to incoming calls for the account in the call log storage unit 220. In step 910, the consolidation unit 118 matches incoming call entries to outgoing call entries from the compared list of call log entries. In step 912, the consolidation unit 118 determines if the outgoing call time is later in time than a matching incoming call. If the time is later, the consolidation unit 118 marks the incoming call as being returned by the identified outgoing call. If the time is earlier than the incoming call, the incoming call remains categorized as a missed call.

In the present disclosure, the words “a” or “an” are to be taken to include both the singular and the plural. Conversely, any reference to plural items shall, where appropriate, include the singular.

It should be understood that various changes and modifications to the presently preferred embodiments disclosed herein will be apparent to those skilled in the art. Such changes and modifications can be made without departing from the spirit and scope of the present disclosure and without diminishing its intended advantages. It is therefore intended that such changes and modifications be covered by the appended claims.

We claim:

1. A message consolidation system comprising:
a plurality of mobile communication devices connected to a network;
a plurality of telecommunication switching units connected to a plurality of communication units and to the network;
a consolidation unit on the network, the consolidation unit configured to logically relate at least two communication devices and to extract call information from each of the mobile communication devices and switching devices and to store the extracted data in a memory of the consolidation unit for display on a display unit coupled to a client device.

2. The message consolidation system of claim 1, wherein the consolidation unit extracts additional information pertaining to the phone numbers in the extracted call information.

3. The message consolidation system of claim 2, wherein the additional information includes information indicating if a call was successfully connected or missed.

4. The message consolidation system of claim 3, wherein the consolidation unit is configured to post a message on an external web site based on a status of a call in the extracted call information.

5. The message consolidation system of claim 3, wherein the consolidation unit is configured to determine if a return call was initiated based on the call information.

6. The message consolidation system of claim 1, wherein the consolidation unit displays a listing of missed and received calls for each of the related communication devices.

7. A method of consolidating call information from a plurality of logically related communication devices connected to a network, the method comprising the steps of:
connecting to each of the communication devices or to a telecommunication switch unit communicatively coupled to at least one of the communication devices;
extracting call information from each of the communication devices or the corresponding telecommunication switch units;
storing the extracted call information in a memory of a consolidation unit;
displaying the call information for at least two logically related communication devices on a display via the consolidation unit.

8. The method of claim 7, including extracting additional information pertaining to the phone numbers in the extracted call information.

9. The method of claim 8, wherein the additional information includes information indicating if a call was successfully connected or missed.

10. The method of claim 9, including posting a message on an external web site based on a status of a call in the extracted call information.

11. The method of claim 9, including the step of determining if a return call was initiated based on the call information.

12. The method of claim 9, including the step of displaying a listing of missed and received calls for each of the related communication devices.

13. The method of claim 11, including the steps of extracting a list of outgoing calls from each of the communication devices or the corresponding telecommunication switch units, and matching the phone numbers and call times of each missed call with an outgoing phone call to determine if a return call has been placed.

14. A message consolidation system comprising:
a consolidation unit configured to logically relate at least one mobile communication device connected to a network and at least one telecommunication switching unit connected to a plurality of communication units and to the network, the consolidation unit configured to extract call information from the at least one mobile communication device and the at least one switching device and to store the extracted data in a memory of the consolidation unit for display on a display unit coupled to a client device.

15. The message consolidation system of claim 14, wherein the consolidation unit extracts additional information pertaining to the phone numbers in the extracted call information.

16. The message consolidation system of claim 15, wherein the additional information includes information indicating if a call was successfully connected or missed.

17. The message consolidation system of claim 16, wherein the consolidation unit is configured to post a message on an external web site based on a status of a call in the extracted call information.

18. The message consolidation system of claim 16, wherein the consolidation unit is configured to determine if a return call was initiated based on the call information.

19. The message consolidation system of claim 14, wherein the consolidation unit displays a listing of missed and received calls for each of the related communication devices.

20. The message consolidation system of claim 14, wherein the consolidation unit is configured to logically relate at least two mobile communication devices.
